(19) United States
(12) Patent Application Publication
(10) Pub. No.: US 2014/0374443 A1
(43) Pub. Date: Dec. 25, 2014

(54) Carbonated Beverage Storage, Transportation, and Dispensing System

(71) Applicant: Young Inventions LLC, Chesterfield, MO (US)

(72) Inventors: Steve Young, St. Louis, MO (US); Jeffrey Macler, Tecumseh, MO (US)

(21) Appl. No.: 14/303,415

(22) Filed: Jun. 12, 2014

Related U.S. Application Data
(60) Provisional application No. 61/838,665, filed on Jun. 24, 2013.
(60) Provisional application No. 61/935,562, filed on Feb. 4, 2014.

(51) Int. Cl. B67D 1/04; B67D 1/12

(52) U.S. Cl. CPC B67D 1/0462; B67D 1/1252; B67D 2001/0092
USPC 222/105; 222/399; 222/400.7

(57) ABSTRACT

A container for the storage, transport and consumption of a carbonated beverage, and specifically a carbonated malt beverage such as, but not limited to, beer, which utilizes a flexible inner container and a rigid outer container (often a wall of the dispenser) which is presented in generally close proximity thereto by having inner dimensions similar to the outer dimensions of the internal bag. In order to dispense the beverage, an external source of gas, which will commonly be carbon dioxide or nitrogen, is used to feed gas directly into the flexible container portion of the device and the beverage itself. This causes the interior container to push against the rigid walls of the exterior container creating pressure and dispensing the beverage.

### CROSS REFERENCE TO RELATED APPLICATION(S)

This application claims benefit of U.S. Provisional Patent Application Ser. No. 61/838,665, filed Jun. 24, 2013, and U.S. Provisional Patent Application Ser. No. 61/935,562, filed Feb. 4, 2014. The entire disclosure of both of these documents is herein incorporated by reference.

### BACKGROUND

1. Field of the Invention

This disclosure relates to systems for storing, transporting, and dispensing carbonated liquids, and particularly beer.

2. Description of the Related Art

Beer is an ancient beverage with records dating back to the 5th Millenium BC making it one of the oldest known human manufactured consumables. Further, beer is one of the most popular beverages in the world. In 2012, in the United States alone, over 200 million barrels of beer were purchased with almost $100 million dollars being spent on the beverage.

One particularly popular facet of beer is it's carbonation. Carbonation, where carbon dioxide (CO2) is dissolved in liquid, occurs in beer through the action of yeast which produces the alcohol and carbon dioxide for which the beverage in known. In addition to beer, a number of other drinks (as well as some beers) are also carbonated by forcing carbon dioxide into the liquid in a variety of processes. Soft drinks, which dramatically rose in popularity during prohibition in the United States, are one such beverage that is generally carbonated. Soft drinks, even compared to beer, are an enormous industry approaching $100 billion in sales per year.

Why carbonated beverages are desirable to humans is not well understood. It is known that drinking a carbonated beverage provides for a very different sensation than drinking a non-carbonated beverage, but the specifics of the taste profile have proven hard to categorize. It has been theorized that the taste sensation of carbonation actually makes the beverage feel “colder” even without the temperature being altered. It's also been theorized that the presence of carbon dioxide can actually mildly trigger pain receptors which may provoke a similar reaction to eating spicy foods, which is also enjoyable for many people. Regardless of what it is that makes carbonated beverages palatable, it is clear that they are.

However, when it comes to carbonated beverages, most humans don't like them when they are no longer carbonated. Most people will not consume flat sodas (those that have lost their carbonation) or flat beer, but will throw them out because they find the taste profile undesirable. Some of this is likely due to the taste profiles of the underlying beverage, particularly in the case of those reliant on artificial forced carbonation, taking into account the presence of the carbonation in their recipes. Thus, when the carbonation is removed, the beverage may taste syrupy or warm because it was intended to be carbonated.

Because of the need to maintain the carbonation in carbonated beverages, packaging for such beverages has become a major industry unto itself. One problem with transporting and storing carbonated beverages is that if the beverage is exposed to the air, or has available expansion space in its container, the dissolved carbon dioxide will relatively quickly outgas from the beverage and cannot be readily placed back in without some form of gas injection. Further, a packaged carbonated beverage can be subject to an explosion risk should the carbon dioxide be forced out (generally though mechanical agitation) while in a confined space. Thus, carbonated beverages are often packaged in containers specifically engineered for strength and gas impermeability.

Typically, carbonated beverages are provided in two different materials. Metals (usually aluminum or steel) and glass. Both materials provide for relatively rigid and strong containers that reduce explosion risk due to their relatively good ability to sustain substantial increases in pressure without rupturing. While carbonated soft drinks have for years also utilized plastic bottles for transport and storage, plastic bottles have only recently begun being used in the beer industry.

Beer, unlike most soda, can be readily damaged by exposure to light, heat, and air beyond it simply losing carbonation. Thus, beer is often a more fragile liquid than soda. Traditionally, plastic bottles have been comprised of Poly(ethylene terephthalate) (PET) for ease of manufacture. While PET does a reasonable job of sealing in carbon dioxide, it is more porous to oxygen which can damage beer. Further, it is often difficult to effectively seal plastic bottles compared to metal or glass. Still further, because resealing the beverage container is generally difficult, most carbonated beverages are sold to end consumers in an amount suitable for consumption in a single sitting.

While other alcoholic beverages, such as wine, have been used in flexible containers, such as bags, enclosed in a cardboard carrier (so called wine-in-a-box) to provide for alternative storage means, these types of structures are generally unsuitable for carbonated beverages. The bag in a box is generally airtight and collapses as fluid is dispensed through the creation of an internal vacuum which can preserve the wine by keeping out oxygen even through multiple dispensing actions. However, with a carbonated beverage, the vacuum formed from evacuating liquid would be readily filled by carbon dioxide dissipating from the beverage. Such dissipation becomes more prevalent as the amount of beverage in a container decreases, and, thus, the available headspace in the container increases. Thus, such a dispensing system is generally unsuitable for carbonated beverages as it suffers from the same problems as more traditional plastic bottles.

Alternatively, in many commercial systems for dispensing carbonated beverages, such as soda fountains and beer taps, carbonation can be forced into the beverage as it is dispensed. This allows the beverage to be transported with reduced carbonation (and often no carbonation) with the carbonation added just prior to consumption. This can also, in certain situations, make it easier to dispense the beverage as the carbon dioxide being input for carbonation can be used to force the beverage liquid from its container as well. However, this type of dispensing is generally confined to manufactured beverages, such as soft drinks, that can be reduced to a non-carbonated form (such as a flavor syrup).

Up until recently, multi-serving containers for beer, which were designed to allow the beverage to last longer than a few hours, were confined to beer kegs and casks. Keg and cask beer systems are effectively sealed containers that avoid the dissipation of carbon dioxide from the beverage into the surrounding atmosphere upon dispensing by filling the atmosphere with additional molecules (usually of carbon dioxide although air can also be used in some cases) as the beverage is dispensed. Even with these additional fill systems, however, keg and cask beer is designed to be consumed relatively rapidly in many cases. These types of containers are also universally heavy and strong and require a large amount of associated mechanical devices and specialized connectors to fill, dispense from, and maintain pressure internal to. As such, they were difficult to use in the home (without the purchase of specialized equipment such as a “kegerator”) and were often confined to commercial applications.

Recently, one of the first flexible containers designed to dispense a carbonated beverage came out in the form of the Draftmark™ system produced by Anheuser-Busch InBev S.A. The system, many facets of which are discussed in U.S. Pat. No. 7,810,679, the entire disclosure of which is herein incorporated by reference, utilizes a flexible PET plastic bag, which is filled with a carbonated beverage (specifically beer). This bag is formed either within a more rigid enclosure in the form of a keg, or inside another bag, and both are placed in a less rigid structure, such as a box.

In order to dispense the beverage, an air pump is connected which supplies external air, under pressure, external to the beverage holding bag, but internal to the next exterior structure. This serves to increase the external pressure on the internal beverage bag by pressurizing the outer cover which, because of the flexible nature of the internal bag, is crushed by the pressure. This prevents there being available headspace in the bag for carbon dioxide to escape the beverage so long as the pressure between the two layers is greater than the pressure generated by the carbon dioxide trying to outgas. Thus, should the bag be initially entirely filled with liquid, the continuous addition of air to the pressurized air space serves to keep air from being able to enter the beverage holding bag, and prevents the carbon dioxide from outgassing from the beverage as the pressure provides it with no additional headspace to go into.

While this system is effective at allowing dispensing and allows it to be dispensed over time, it suffers from a number of major flaws. The first and most major of which is that the system can generally not be refilled by the end consumer. Once the internal bag is empty, the entire product generally needs to be disposed of as there is no easy way to release the air from the air space to allow it to be refilled. Thus, there is no way for the consumer to fill the beverage bag with a beverage of their choosing, they are instead forced to accept whatever the bags are filled with commercially.

Further, the use of a PET bag in an air-based atmosphere (as is present from air in the outer structure providing the pressure on the inner bag) exposes the beer in the inner bag to oxygen in the same manner as a plastic bottle, resulting in a shorter lifespan. Still further, the beer in the system is often plagued by foam as the need to have and maintain a greater pressure external to the liquid bag of beverage can result in forcing highly carbonated beverage in the form of foam from the dispensing spigot when the spigot is opened.

### SUMMARY

The following is a summary of the invention in order to provide a basic understanding of some aspects of the invention. This summary is not intended to identify key or critical elements of the invention or to delineate the scope of the invention. The sole purpose of this section is to present some concepts of the invention in a simplified form as a prelude to the more detailed description that is presented later.

Because of these and other problems in the art, described herein is a container for the storage, transport and consumption of a carbonated beverage, and specifically a carbonated malt beverage such as, but not limited to, beer, which utilizes a flexible inner container and a rigid outer container (often a wall of the dispenser) which is presented in generally close proximity thereto by having inner dimensions similar to the outer dimensions of the internal bag. In order to dispense the beverage, an external source of gas, which will commonly be carbon dioxide or nitrogen, is used to feed gas directly into the flexible container portion of the device and the beverage itself. This causes the interior container to push against the rigid walls of the exterior container creating pressure and dispensing the beverage.

As the exterior container is built to withstand such pressure without substantial deformation, the connection between the two containers serves to inhibit rupture of the inner flexible container which is pressurized, and inhibits the inner container from any additional expansion resulting in increased pressurization of the bag generally forcing the carbonated beverage to a point of local weakness, which will generally be a dispensing spigot or other valve system. The beverage is, thus, generally dispensed by pressurizing the beverage containing bag to at least 1 atm of pressure (or any amount at or above ambient in the present location of the bag) which results in the beverage (and some of the dispensing gas) being forced out of a spigot, which is also attached to the inner bag, and into a waiting vessel.

There is described herein, in an embodiment, a system for storing and dispensing a carbonated fluid, the system comprising: a flexible bag including a carbonated liquid therein; said bag including a connector allowing for liquid flow into and out of said bag and a connector for allowing gas flow into said bag; a rigid sleeve sized and shaped to encapsulate said bag, said bag contacting said sleeve when said bag is filled with a carbonated fluid and internally pressurized; a gas source, said gas source connected to said connector for allowing gas flow into said bag so as to provide gas into said bag which gas internally pressurizes said bag; a regulator to control gas flow into said bag and liquid flow from said bag so that internal pressure of said bag can be maintained during dispensing of said carbonated liquid; and an outer housing enclosing said bag and said sleeve.

In an embodiment of the system, the gas provided by said gas source comprises carbon dioxide.

In an embodiment of the system, the gas provided by said gas source comprises nitrogen.

In an embodiment of the system, the carbonated liquid is a malt beverage.

In an embodiment of the system, the said malt beverage comprises beer.

In an embodiment, the system further comprises a source of refrigerant for reducing a temperature of said carbonated liquid.

In an embodiment of the system, inner dimensions of said rigid sleeve correspond to outer dimensions of said bag.

In an embodiment of the system, inner dimensions of said rigid sleeve are smaller than outer dimensions of said bag.

In an embodiment of the system, the connector allowing for liquid flow into and out of said bag is a separate connector from said connector for allowing gas flow into said bag.

In an embodiment of the system, the connector allowing for liquid flow into and out of said bag and said connector for allowing gas flow into said bag are the same connector.

In an embodiment of the system, the connector allowing for liquid flow into and out of said bag and said connector for allowing gas flow into said bag are located at different parts of said bag.

There is also described herein, in an embodiment, a method for dispensing a carbonated fluid, the method comprising: providing a flexible bag including a carbonated liquid therein; said bag including a connector allowing for liquid flow into and out of said bag and a connector for allowing gas flow into said bag; providing a rigid sleeve sized and shaped to encapsulate said bag, said bag contacting said sleeve when said bag is filled with a carbonated fluid and internally pressurized; injecting a gas via said connector for allowing gas flow into said bag to internally pressurize said bag; and withdrawing liquid from said bag while maintaining the internal pressure of said bag.

In an embodiment of the method, the said gas comprises carbon dioxide.

In an embodiment of the method, the said gas comprises nitrogen.

In an embodiment of the method, the carbonated liquid is a malt beverage.

In an embodiment of the method, the malt beverage comprises beer.

In an embodiment, the method further comprises reducing a temperature of said carbonated liquid.

In an embodiment of the method, inner dimensions of said rigid sleeve correspond to outer dimensions of said bag.

In an embodiment of the method, inner dimensions of said rigid sleeve are smaller than outer dimensions of said bag.

In an embodiment of the method, the connector allowing for liquid flow into and out of said bag is a separate connector from said connector for allowing gas flow into said bag.

In an embodiment of the method, the connector allowing for liquid flow into and out of said bag and said connector for allowing gas flow into said bag are the same connector.

In an embodiment of the method, the connector allowing for liquid flow into and out of said bag and said connector for allowing gas flow into said bag are located at different parts of said bag.

### BRIEF DESCRIPTION OF THE DRAWINGS

FIG. 1 provides a perspective view of an embodiment of an exterior housing of a counter-top dispensing unit.

FIG. 2 provides a front view of the embodiment of FIG. 1.

FIG. 3 provides a side view of the embodiment of FIG. 1.

FIG. 4 provides a rear view of the embodiment of FIG. 1.

FIG. 5 provides a top view of the embodiment of FIG. 1.

FIG. 6 provides a bottom view of the embodiment of FIG. 1.

FIGS. 7A-7B provides an embodiment of a flexible bag suitable for the storage of carbonated beverages. FIG. 7A is a front view and FIG. 7B is a side view.

FIG. 8 provides an alternative embodiment of a flexible bag suitable for the storage of carbonated beverages.

FIG. 9 provides a still further embodiment of a flexible bag suitable for the storage of carbonated beverages.

FIG. 10 provides an embodiment of sleeve and bag combination that comprises a hinged clamshell lid with two removable end plates.

FIG. 11 provides an embodiment of a dispenser including the combination of FIG. 10.

FIG. 12 provides an embodiment of a two-part regulator comprising a standard keg coupler and an adapter.

FIG. 13 provides an embodiment of a drop tube adapter for use in a dispenser where the bag connector is located at the top or side of the bag during dispensing and an adapter between a screw connector and valve arrangement is desired.

### DESCRIPTION OF THE PREFERRED EMBODIMENT(S)

This disclosure is primarily focused on a household appliance or device which is suitable for the home dispensing of carbonated malt beverages such as, but not limited to, beer and the storage of such beverages in such a device when the malt beverage has not been subject to traditional packaging methods (such as bottling, canning, or kegging) but is obtained in a “draft” form. That is, from a tap such as, but not limited to, in a bar, tap room, or brewery, or provided directly from a fermentation vessel, such as, but not limited to, a fermentation tank or bright tank. While the present disclosure is focused on beer dispensing, it should be recognized that the appliance, components thereof, and the methods of their operation can be used for any carbonated fluid. This can include, but is not limited to, sodas, non-alcoholic carbonated fruit juices, alcoholic fruit juices such as cider or peary, mead, energy drinks, sparkling wines, carbonated waters, and combinations thereof. Still further, while the systems and methods discussed herein are particularly useful for carbonated beverages, the systems can also be used to dispense non-carbonated beverages as well, such as, but not limited to, wine, liquors, waters, fruit juices, milk, coffee, tea, and non-carbonated soft drinks.

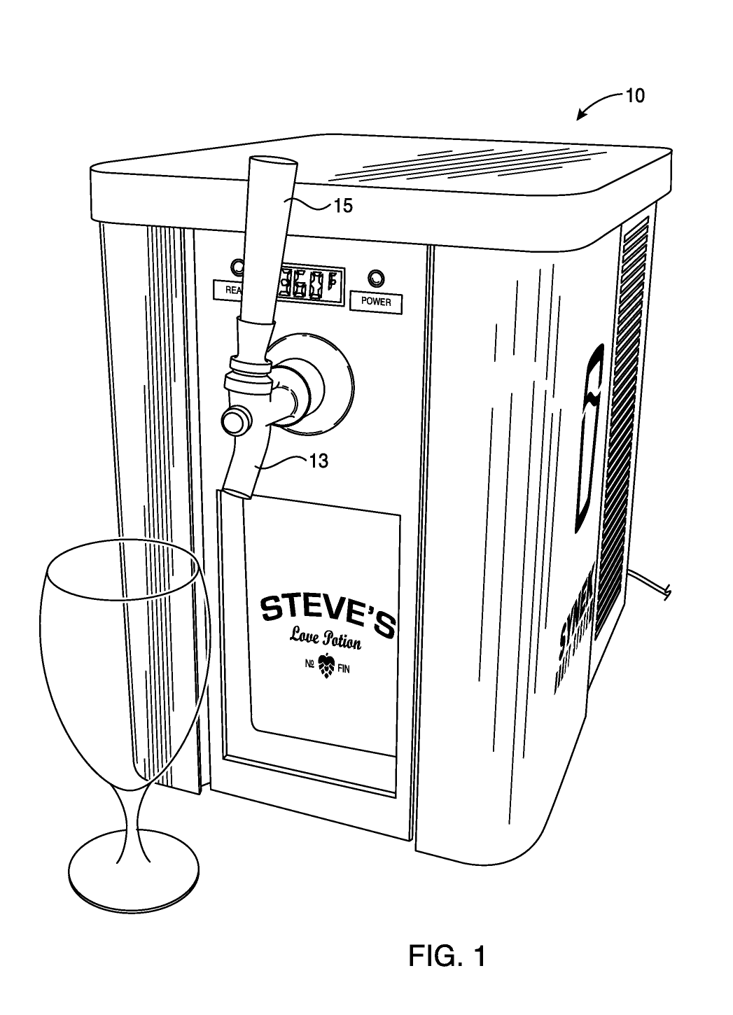

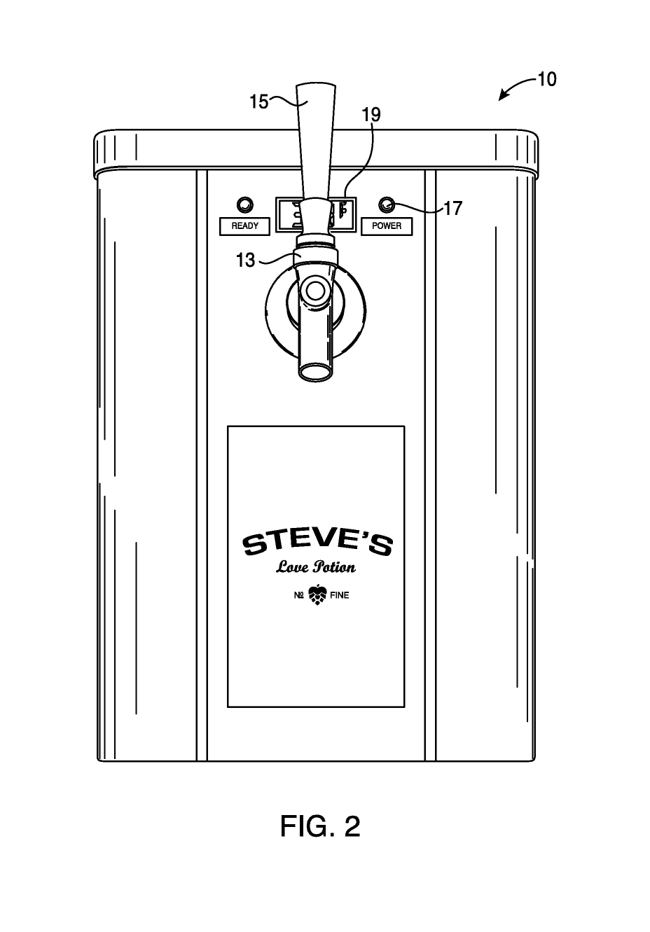

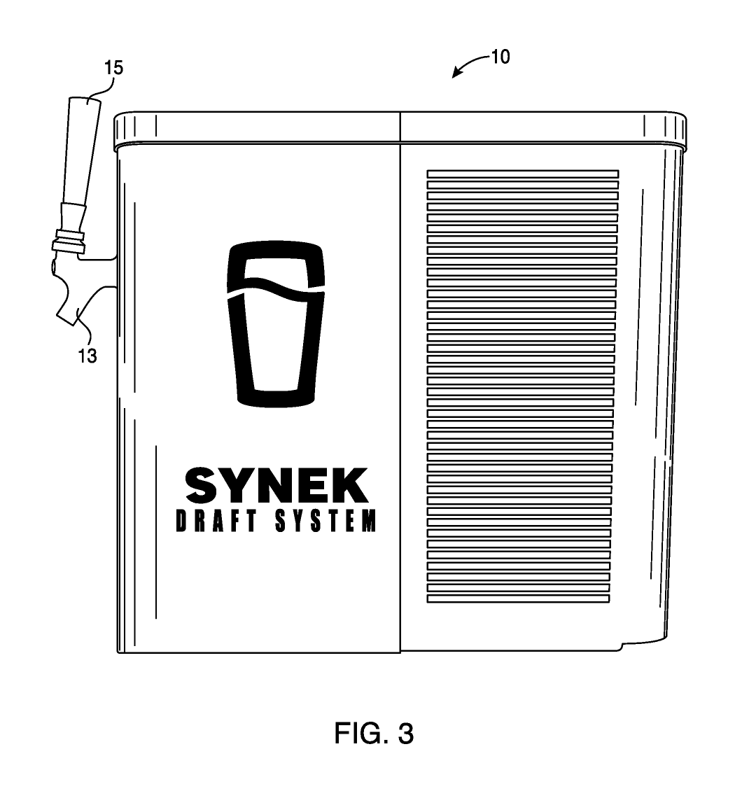

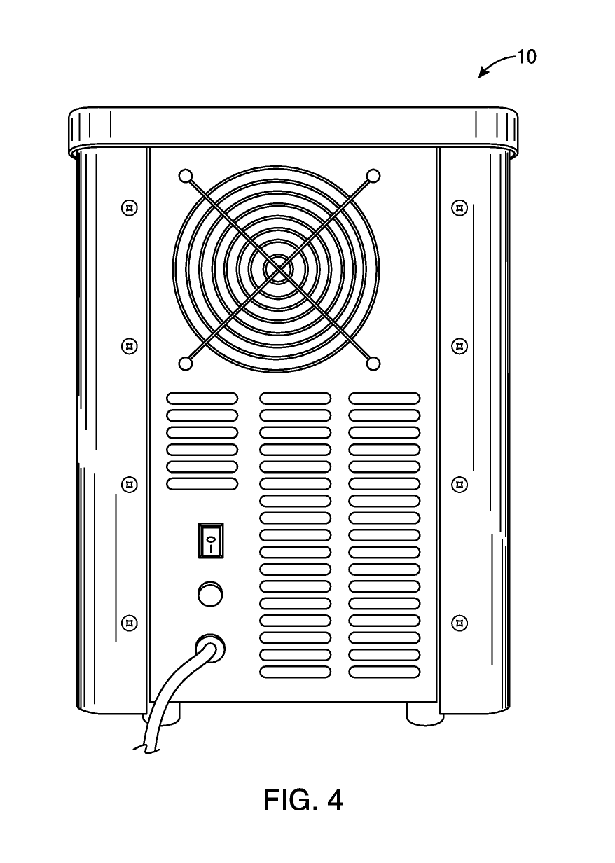

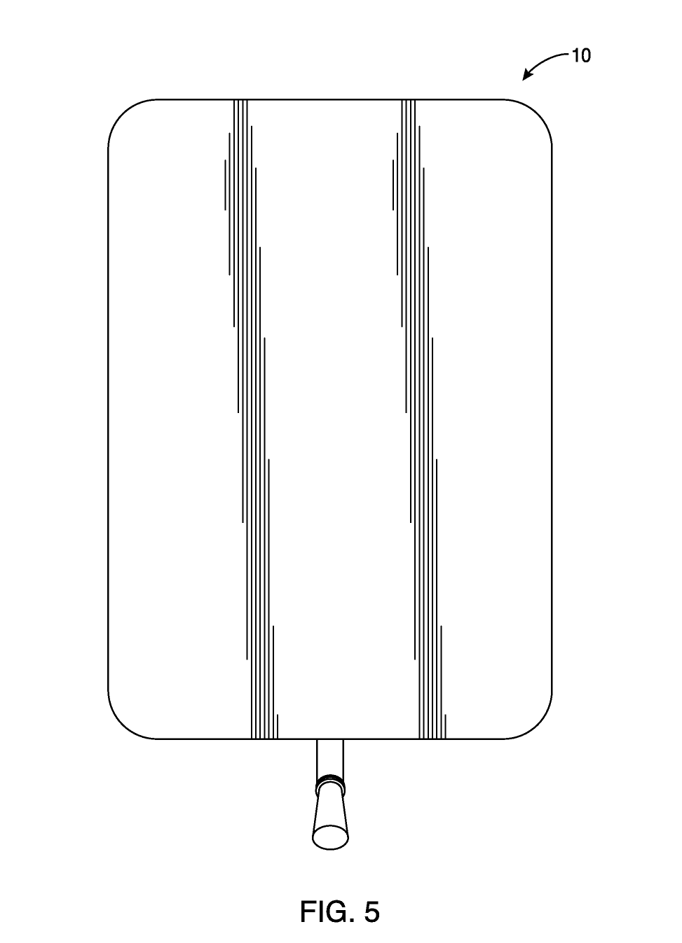

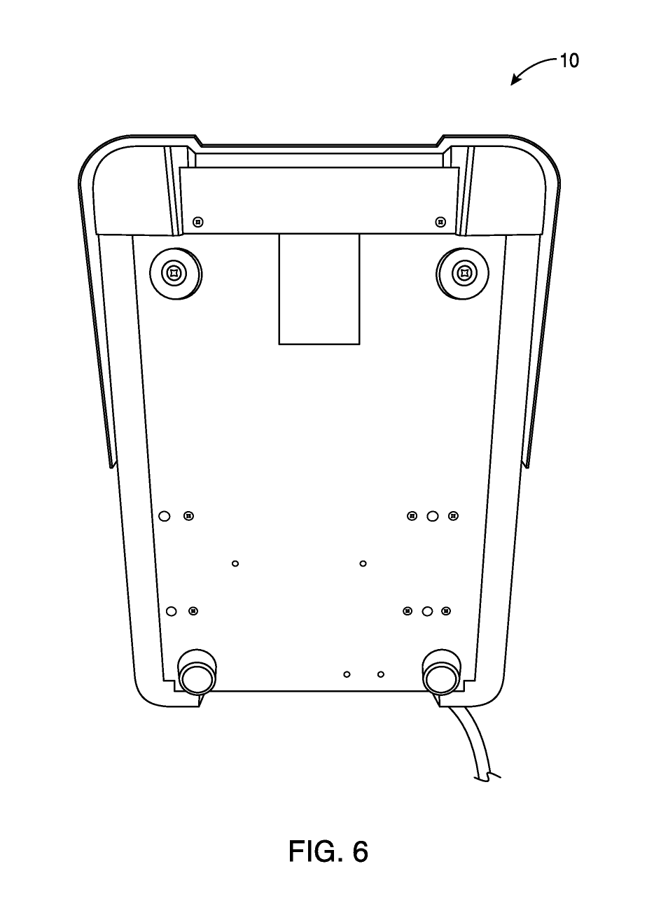

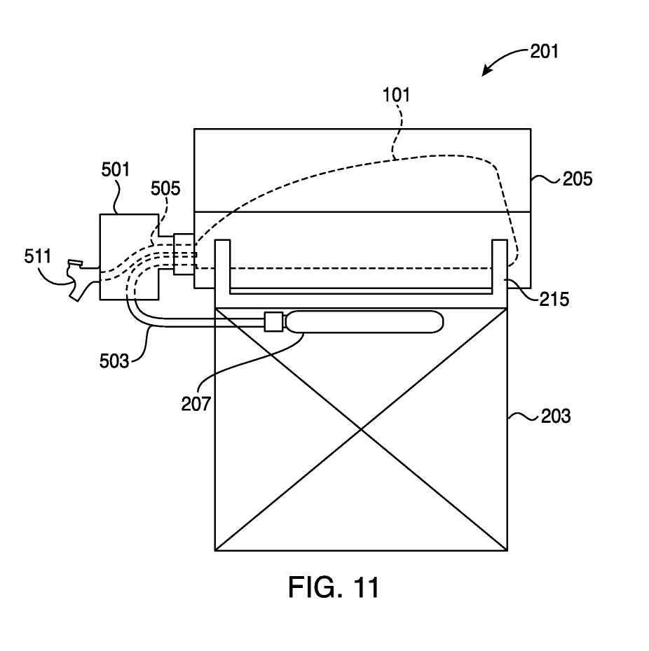

FIGS. 1-6 provide for an embodiment of a counter-top unit (10) which may be used in the dispensing of a carbonated beverage. The unit (10) is generally designed to resemble a standard kitchen appliance and may include a traditionally formed tap (13) and handle (15) as is common in the dispensing of beer. The unit (10) will internally include structure such as that shown in FIG. 11 and will provide for beer in a flexible package (a “bag”) (101) which can be dispensed via the tap (13). The unit (10) also may include additional elements such as a gas source (207) as shown in FIG. 11 or a refrigerant source of the type known to one of ordinary skill in the art (not shown) to provide refrigeration internal to the unit and thus refrigerating the bag (101). In order to assist in the preservation of the internal beverage, should refrigeration be provided the unit (10) will often include indicators for power (17) and temperature (19) to allow for a user to verify correct operation of the unit. The unit (10) also may include a viewing window (21) where the user may place an indicator of the type of beer in the unit (10) or monitor the amount of beer remaining in the bag (101).

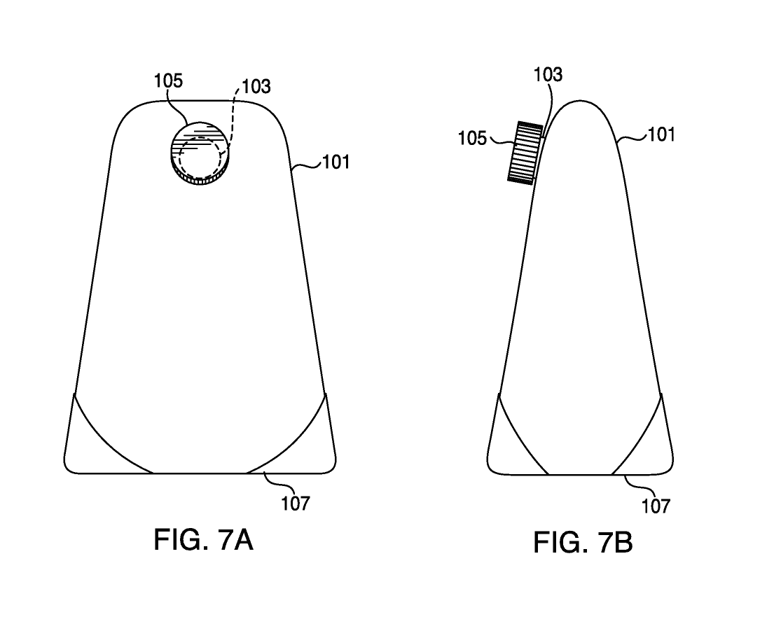

As indicated above, the unit (10) will generally house a flexible package for storage of the liquid (generally referred to as a bag) (101). FIGS. 7A and 7B provide, respectively, a front and side view of an embodiment of a liquid containing container (101) suitable for use with carbonated beverages. The container (101) may be of any shape, but is depicted in a traditional triangular bag shape and includes an opening along with an associated connector (103) and cap (105). The container (101) may be filled with any beverage, but this disclosure will focus on its use with carbonated beverages and specifically beer. The interconnection between the connector (103) and cap (105) will generally be designed to be tight fitting to provide a barrier sufficient to inhibit liquid passage such as, but not limited to, via mating screw connectors. In an embodiment, the connection may provide an airtight barrier once the cap (105) is connected on the connector (103). This is, however, generally considered beneficial but unnecessary as the cap (105) may only be used for temporary closure.

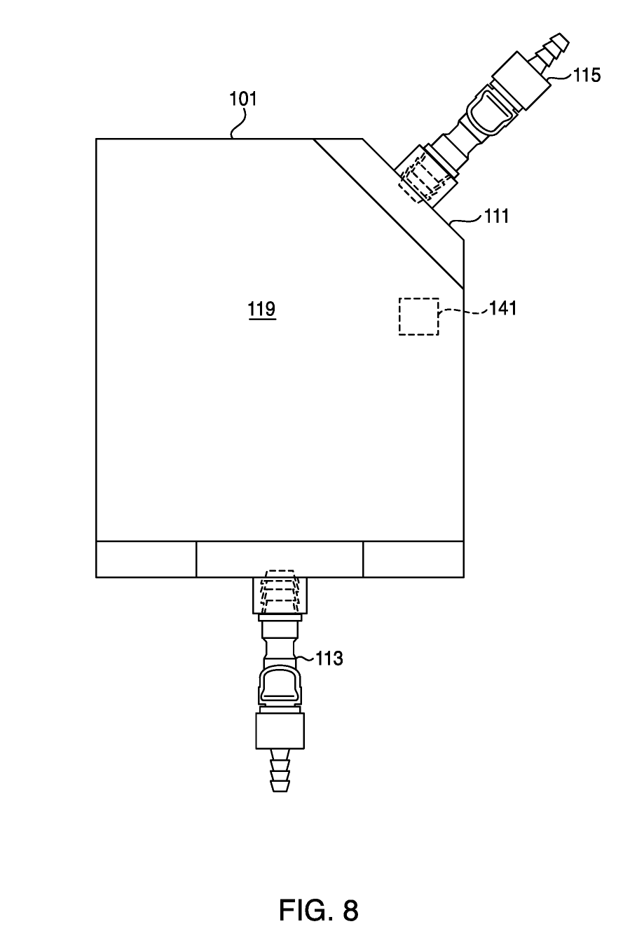

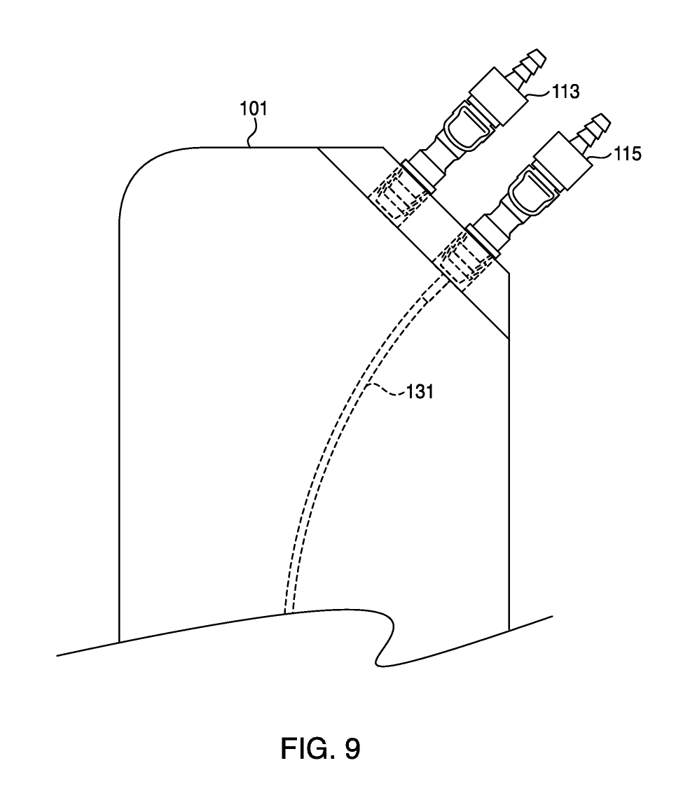

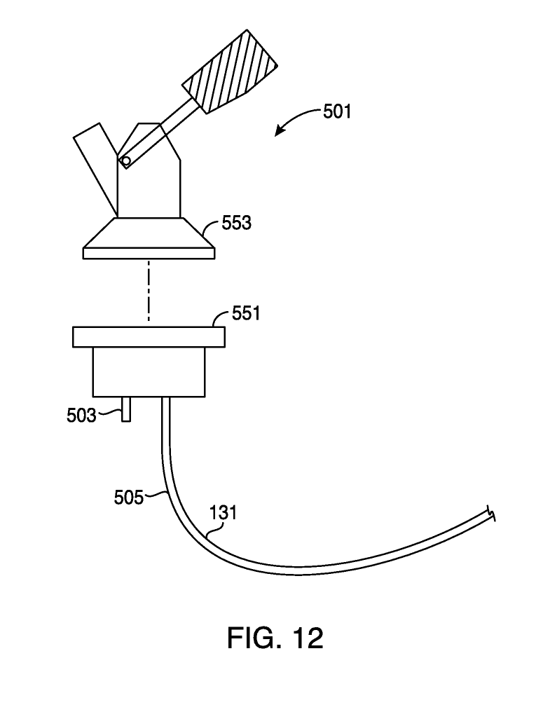

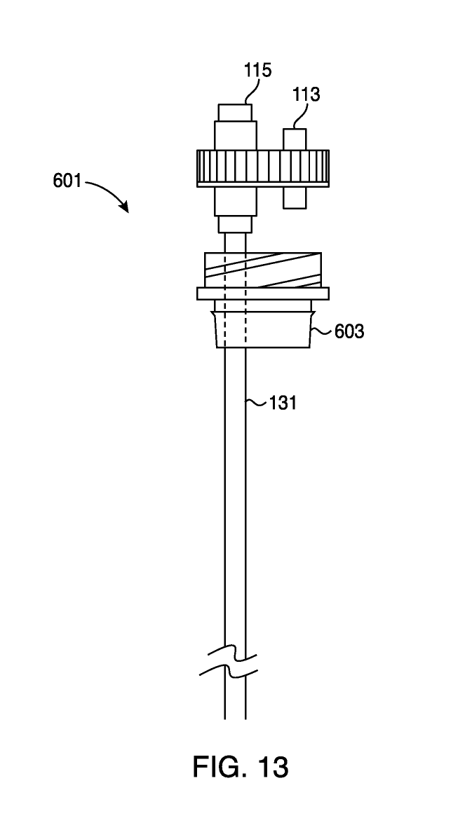

FIGS. 8 and 9 provide for two additional embodiments of bags (101). These bags (101) generally include a “boat” seal (111) and do not utilize a screw connector (103) for the opening. Instead, these embodiments utilize two quick or snap connector valves (113) and (115) which are designed to provide for a valve arrangement internal to their structure. Suitable devices for connectors (113) and (115) include those being sold by Colder Products as NSF Series valved connectors. Specifically, the connectors (113) and (115) provide that the associated openings are sealed unless a mating connector is pushed into the connector (113) or (115) which serves to open the valve (113) or (115). Thus, the inside of the bag (101) is generally never exposed directly to the outside. Instead, it is only exposed when an object is connected to the connectors (113) and (115). Generally, valve (113) will be used to provide gas input and valve (115) will provide liquid input and output eliminating the need to use a regulator adapter (501) as shown in FIG. 12 or the adapter (601) of FIG. 13. In an embodiment, a bag (101) which utilizes valves (113) and (115) may be initially provided with the interior of the bag vacuum excavated. This can allow for the bag (101) to be provided to an end user in what is essentially an internally sanitary state and allow it to be filled with reduced or no exposure to air, potentially improving shelf life of the included beverage.

Regardless of its shape, the bag (101) may be designed to allow it to self-stand such as on base (107) as shown in FIG. 7. Alternatively, the bag (101) may be designed to lay on one of its flat major surfaces (119). This can make for easier filling and storage. It also may be designed to fold generally flat when empty. Regardless of its shape, the bag (101) will generally be designed so as to be of a particular shape and size when considered completely filled. That is, the bag (101) will have generally fixed dimensions beyond which it will not increase even as it is placed under pressure. To say it differently, while the material of the bag (101) is flexible, it is not expandable or stretchable, and will generally rupture as opposed to expanding or stretching if placed under enough pressure. This is different, than say a latex balloon, which is designed to stretch and expand under pressure.

The bag (101) may be constructed of any generally flexible non-expandable material and will generally be constructed of a metal foil, metalized plastic, or multi-layer material including some form of metal, but that is not required. In an embodiment, the bag (101) is constructed of a 3-layer material comprising a layer of metal foil (commonly aluminum or steel) sandwiched between two layers of polyester, Nylon, polyethylene, or another resin or plastic. These types of materials present good gas barriers, particularly for oxygen, while still allowing the material to be flexible and relatively inert. The bag (101) material will generally be quite thick so as to be strong and resilient, but the specifics of the construction will depend on desired resultant characteristics as would be understood by one of ordinary skill in the art.

When the user wishes to utilize the bag (101) with a carbonated beverage, the operation depends somewhat on the type of bag being used. With the embodiment of FIGS. 7A and 7B, the user will simply open the cap (105), and fill the bag (101) with the carbonated beverage. It is important to recognize that the beverage will not be placed in the bag (101) in a specific state to avoid the presence of carbonation, but may be provided in any state and is preferably provided in the state in which it is intended to be consumed. In the case of beer, the beverage is expected to be dispensed directly from a beer tap, cask, or brewing tank which is already carbonated to the desired amount. Alternatively, the bag (101) may be filled with a nitrogen dispensed beer or may be filled with beer or beverage from a more traditional container, such as a bottle or can. In this way, the bag (101) is effectively the equivalent of a “growler” or other glass container designed to be filled with a carbonated beverage dispensed directly in a ready-to-drink state.

In the embodiments of FIGS. 8 and 9, the bag (101) can generally not be filled directly from a tap as the beer exiting the tap will generally lack sufficient force to overcome the valve (115). In these embodiments, there will generally be provided a fill adapter which is similar to the traditional growler fill tubes known to those of ordinary skill Such a fill adapter would generally comprise a length of flexible hollow tubing sized and spaced to interconnect with the spigot of the tap at a first end. The opposing end would generally have a connector designed to mate with connector (115) and open the valve (115). This will allow for fluid flow directly from the tap into the bag (101) without exposure of the fluid to air.

Nitrogen dispensed beer (commonly called “nitro”) does not primarily utilize carbon dioxide gas in its carbonation. Instead, the beer is dispensed using a gas which is typically around 70% nitrogen and 30% carbon dioxide. Nitrogen is generally not soluble in beer and therefore the gas is generally forced into a mixture with the beer through the dispensing system. This results in bubbles which will slowly rise in the beer and dissipate creating a thick foamy beer head commonly associated with stouts. One expected advantage of the present system is that it can be used to store and dispense nitro beers.

Regardless of the type of dispensing used on the beverage, the beverage will generally be dispensed directly into the bag (101) in the same manner that keg beer is already typically dispensed into glass or metal growlers for home consumption. An important facet of such dispensing is that, as opposed to dispensing into a drinking vessel, dispensing into a storage container such as a growler is generally done utilizing an adapter for the tap which dispenses the beer toward the bottom of the container to reduce outgas sing from mechanical agitation and preserve the carbon dioxide dissolution. Further, a growler, and the present bag (101) will generally be filled very full with only a very small amount of headspace being present.

Once the bag (101) is filled, it will be tightly closed with the cap (105) (or adapters can be removed to allow for valves (113) and (115) to close) and transported. For some users, the bag (101) can be used as is in the same fashion that a traditional glass growler would be used and it will provide much the same function. The bag (101) is generally better than a traditional growler in that it is generally significantly harder to break, can be designed to provide for a very effective seal in the cap (105), and may be more suitable for transport such as, but not limited to, being able to be readily carried in luggage or shipped using commercially available shipping methods. The bag (101) also can provide for significantly increased functionality when combined with a unit (101) or dispenser (201) as shown in FIG. 1-6 or 11.

In FIG. 11, the bag (101) is placed for dispensing inside a dispenser (201) which may be a stand-alone unit or positioned inside a housing unit (10), such as shown in FIGS. 1-6. The dispenser (201) will generally comprise a frame (203) which will allow the dispenser (201) to rest on a surface such as, but not limited to, a counter top or shelf, The dispenser (201) also includes a rigid sleeve (205). The rigid sleeve (205) may be generally permanently mounted to the frame (203) or may be designed to be removable, as depicted, and rest in a cradle (215).

The frame (203) also may include thereon a gas source (207). The gas source (207) may be a compressed gas source such as a traditional tank of carbon dioxide or nitrogen (which may be stored in liquid form and allowed to form gas as it is dispensed as is well understood to those of ordinary skill in the art). Alternatively, it may comprise an air pump and filter which can be used to separate nitrogen and/or carbon dioxide from ambient air. Still further, the source (207) may comprise a variety of chemicals (for instance sulfuric acid and chalk or dry ice and water) which are known to generate a specific gas when reacted together. These can then be reacted in a controlled fashion to produce a measured amount of gas. It will be appreciated by one of ordinary skill that virtually any gas source (207) may be used which is known now or later developed. Further, while the gas source (207) is generally preferred to provide carbon dioxide and/or nitrogen, it should be recognized that other gases can be provided as can a mixture of gases.

While other gases can be provided in alternative embodiments, oxygen exposure is generally considered very detrimental to beer. Thus, while an oxygen source could be used in some embodiments, that would generally only be for very advanced users. Instead, most users would want to avoid oxygen getting into the beer to provide it with a longer shelf life. To provide for increased shelf life, the inside surface of the bag (101) or another component internal to the bag (for example the drop tube (131)) may include a scavenger patch (141). The scavenger patch (141) will generally include a chemical or device which is capable of removing certain chemicals from the interior environment of the bag (101). Generally, the scavenger patch (141) will be provided to scavenge oxygen from the air inside the bag (101) to provide the beer with a longer shelf life. However, it may be used to scavenge for other materials including harmful bacteria (e.g. as an antibacterial or antimicrobial), or certain chemicals which are known to flavor beer in a negative fashion (e.g. diacetyl).

The dispenser (201) also may include additional components which may be useful for the storage and/or dispensing of beer. In an embodiment, the dispenser (201) may include refrigeration coils or another cooling apparatus positioned and designed to lower the temperature of objects within the sleeve (205). These types of structures are well known to those of ordinary skill in the art and are common in devices such as office water coolers in a variety of forms. The dispenser may include a housing unit (10) around the outside thereof to provide for an improved appearance as indicated above, or may be designed to operate simply as a frame structure without aesthetic modification.

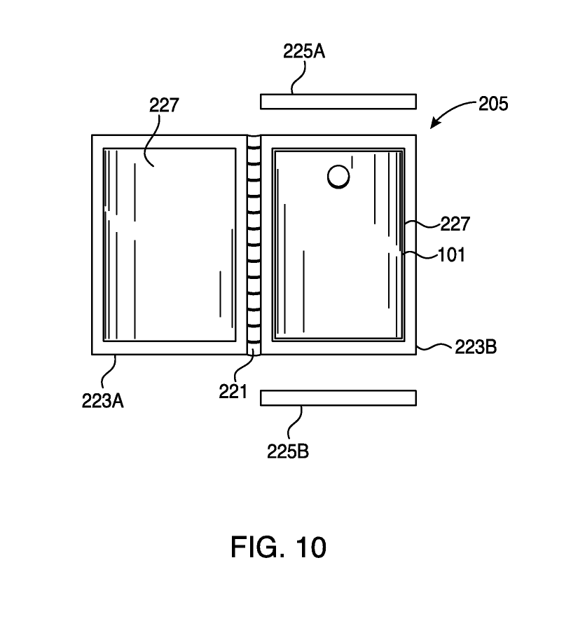

One part of the dispenser (201) is the sleeve (205) which is specifically constructed to interact with the bag (101). Specifically, the sleeve (205) is generally sized and shaped so that it's interior dimensions closely match the exterior dimensions of the bag (101) when the bag (101) is completely filled with fluid (liquid or gas). Alternatively, the sleeve (205) may have dimensions which are smaller than those of the inner bag (101). Thus, if the inner bag (101) is of generally cylindrical external form with an outer diameter of D and a height of H, the sleeve (205) will also generally be of generally cylindrical internal form with an inner diameter of D and inner height of H, or just slightly smaller. An embodiment of a sleeve (205) with a bag (101) arranged therein is provided in FIG. 10.

The bag (101) will generally be placed in the sleeve (205) for dispensing using the dispenser (201). This positioning may be facilitated by additional structures, such as by having the sleeve (205) be breakable into multiple separable or attached components, such as the hinged (221) structure shown in FIG. 10, or by having support arms or related structures designed to assist with handling the flexible bag and placing the bag into the sleeve (205). Once the bag (101) is positioned within the sleeve (205), the sleeve will generally be closed about the bag (101). In the embodiment of FIG. 10, this is accomplished by having the bag (101) placed inside the two halves (223A) and (223B) of a hinged (221) clamshell forming the sleeve (205). The two parts (223A) and (223B) are then rotated about hinge (221) to connect and latch them together. In the depicted embodiment, instead of the two halves (223A) and (223B) including ends, separate ends (225A) and (225B) are provided which interlock with the halves (223A) and (223B) to tightly seal the sleeve (205) around the bag (101).

As should be apparent, the bag (101), when placed in the sleeve (205) will generally be at least partially full of liquid in the form of the beer or other beverage. The bag (101) also may include some additional air or gas. As the interior dimensions of the opening (227) of the sleeve (205) are very close to the exterior dimensions of the bag (101), the bag (101) will generally fit tightly within the sleeve (205) which is why the sleeve (205) structures can potentially open to assist with placement. Once the bag (101) is within the sleeve (205), the entire combination may be placed in the cradle (215) of dispenser (201).

Once the bag (101) is within the dispenser (201), the cap (105) will generally be removed and replaced with a regulator (501) as shown in FIG. 12 or an adapter (601) as shown in FIG. 13. FIG. 11 depicts an embodiment with a regulator (501) in place. It should be recognized that depending on the positioning and design, the regulator (501) may actually be attached to the bag (101) before the bag (101) is placed in the sleeve (205) or after the bag (101) is placed in the sleeve (205) but before the sleeve (205) is placed in the cradle (215) in other embodiments.

The regulator (501) will generally comprise a modified cap which is designed to attach to the connector (103). It may utilize the same connection as cap (105) or may be designed to interact with the bag (101) differently. The regulator (501) is designed to include two fluid pathways (503) and (505) each of which will be designed to provide a single direction of motion through the inclusion of valves and related structures. This includes, but is not limited to, Venturi valves. The first pathway (503) will generally provide for one direction of fluid motion from the gas source (105) into the bag (101) while the second (505) will provide for fluid flow of beverage from within the bag (101) to an attached spigot (511) which can be used to dispense a fluid and/or fluid/gas combination from the bag (101) into a waiting vessel such as a glass, cup, or tumbler.

The regulator (501) will be designed to engage the connector (103) in place of the cap (105) forming a strong, generally airtight, seal. This may be accomplished by having the two elements screw together, or by any form of connection known to those of ordinary skill. Further, the regulator (501) may attach directly, or may attach via an adapter or similar mechanism. For example, in the embodiment of FIG. 12, there is included an adapter (551) which is designed to be screwed into the connector (103) and includes piping which will be used to provide for the portions of the first (503) and second pathways (505) within the bag (101). The adapter (551), may then include valves (not shown) which can close these pathways (503) and (505). In the embodiment of FIG. 12, the adapter (551) is actually specifically designed to provide a face plate which is in the form of a traditional keg connection such as, but not limited to, a US Sankey Keg, a German Keg, or a European Sankey Keg connection. Ball and pin lock connectors may also be used. The adapter (551) may then be connected to a standard keg coupler (553) in the standard fashion to form a regulator (501).

FIG. 13 provides for an adapter (601) like that of FIG. 12. However, the adapter (601) is designed to provide for connectors (113) and (115) to be connected to the connector (103) via the conversion adapter (603). This can allow for interchangeability between different types of bags depending on what is desired by the end user. Further, use of connector (113) to a gas source may allow for an embodiment where the gas source (503), which is part of the unit (10), to be removed or bypassed and a user can easily utilize an external gas source via an adapter to their source. This can allow for advanced users who may have access to large gas sources (such as many home brewers have as part of their standard keg dispensing systems) to utilize those in conjunction with the unit (10).

Once connected to the regulator (501), the bag (101) is ready to dispense. As should be apparent, the bag (101) is now part of a generally closed system and the beverage in the bag (101) is generally in an airtight structure formed from the connector (103), regulator (501), and bag (101).

In certain embodiments, the bag (101) may be mounted in a position where the connector (103) or (115) for dispensing liquid is not a gravitational low point of the dispenser (201). In this arrangement, the bag (101) may be provided with a drop tube (131) which will serve to connect the connector (103) or (115) to a generally gravitational low point to allow for fluid to be dispensed from the bottom of the bag (101).

In order to dispense beer from the bag (101), the user would generally operate a switch, which may comprise any form of spigot (511) known to those of ordinary skill in the art or may be separate from the spigot (511). In the embodiment of FIG. 11, the switch is simply a portion of the spigot (511). When the spigot (511) is activated, the pathway from the gas source will generally be opened and gas will be allowed to be dispensed into the bag (101). This may be through purposefully opening a valve in the line (503), or may occur due to pressure differentials in an automated fashion.

The gas flowing into the bag (101) will cause the bag (101) to expand to the maximum dimensions allowed by the smaller of it and the sleeve (205) in which the bag (101) is placed. Generally, this will be the sleeve (205). Upon the exterior of the bag (101) becoming pressed into the interior of the sleeve (205), further expansion of the bag (101) will generally be inhibited by the sleeve (205) and a continued flow of gas will generally cause the valve in the spigot line (505) to open as this is essentially the weak point of the system. Alternatively, the act of initiating gas flow may simultaneously open the line (505) to the spigot (511). At this time, the beverage, as well as any dissolved gas (including, potentially, gas that is currently being injected) will be dispensed into the waiting vessel for consumption. It should be recognized that the gas being injected into the bag can be injected either into the headspace (or gas-filled) portion of the bag (101) which will generally preserve the carbonation level of the beverage as it is, or can be injected into the beer (fluid-filled) portion of the bag (101) which will generally provide for increased carbonation. In an embodiment, this injection location may actually be selected by the end user.

Once dispensing is complete, the spigot (511) will be returned to the “off” position closing the valve and thereby allowing gas entry and eventually the valve for spigot (511) dispensing. When gas stops flowing through line (503), the pressure in the bag (101) will quickly reach a steady state due to the flow of beverage through line (505). Once the steady state is achieved, the regulator (501) will generally inhibit flow through either line (503) or (505).

As should be apparent, the gas being fed is preferably carbon dioxide or nitrogen, both of which are generally inert and can be used to preserve beer in more traditional bottles or cans. As such, the inclusion of additional gas will generally not have an effect on the beer in the bag (101). Further, as the beer was provided with an initial amount of carbonation when the bag (101) was filled, and, as discussed above, the bag (101) is generally filled almost completely initially, the amount of dissolved carbon dioxide in the beer will generally remain relatively stable over a relatively extended period of time even once some of it has been dispensed from the bag (101). Make-up carbon dioxide will fill all available headspace in the bag (101) inhibiting outgassing of already dissolved carbon dioxide from the beverage. Still further, as the walls of the bag (101) will generally be pressed into the sleeve (205), the system also can provide that there is little room for air proximate to the exterior of the bag (101) which can further help with preservation.

Once the beverage in the bag (101) has been entirely consumed, the bag (101) will generally be removed from the regulator (501) and any remaining gas inside the bag (101) is allowed to dissipate. This may occur simply by disconnecting the regulator (501) or through any other means known to one of ordinary skill in the art. While the bag (101) may be somewhat pressurized at this time, it should be recognized that it need not be much greater than ambient pressure. Once empty, the bag (101) may then be washed, potentially sterilized, and reused in the same fashion or may be disposed of and replaced with another.

It should be recognized that depending on the construction of the regulator (501), cap (105), and connector (103), the bag (101) may be repeatedly removable and replaceable even when partially full, allowing the owner of the dispenser (201) to swap out different beers depending on what they wish to dispense. Specifically, in an alternative embodiment, the valve components of the regulator (501) are included within the bag (101), connector (103), and/or cap (105), or may be provided as part of an adapter (551). Once these valve components are in place, the remaining portions of the regulator (501) may simply be connected and disconnected in a standard fashion and on demand.

When the user wishes to swap out the bag (101) for another while the first still includes beverage to be stored, the user will simply disconnect the regulator (501) leaving the adapter (551) components in place so the bag (101) remains sealed and pressurized regardless of how much fluid is within it. The bag (101) can then be replaced with another bag (101) (or can be removed in combination with the sleeve (205) and replaced with another sleeve(205) and bag(101) combination) and dispensing from the new bag (101) can commence.

In addition to providing on-demand dispensing of an essentially limitless number of beverage options, in an embodiment, the system can provide for the ability of a user to actually create their own beverage creations. For example, in an embodiment, the user can utilize a nitrogen gas source (105) and can fill the bag (101) with a beer or beverage which is not intended to be dispensed with nitrogen. This can allow a home user to effectively have a “nitro” tap without having to invest in a significant system. Still further, the gas source (105) could be replaced with a non-standard gas source. For example, pure oxygen could be used. This would create a beverage product which currently does not exist.

Still further, the system can provide for additional points allowing customization of the resultant beverage. In an embodiment, the regulator (501) could include a purposefully one-way outgassing port which allowed the user to purposefully release gas from the beverage. This could allow them to purposefully “flatten” a beverage, and then utilize the system to provide a different gas or a fixed determined amount of a specific gas to create their own carbonation properties. Thus, a person who purchased a beer that they thought had too much carbonation, could purposefully reduce the carbonation to a fixed amount, and then maintain and dispense the beer with that reduced amount.

In a still further embodiment, two or more regulators (501) could be slaved together so that the system can simultaneously dispense beverage from two or more bags (101) as a mixture. This allows a user to blend beverages as they are placed into a vessel which could provide for more through mixing than normally available with mixing in a drinking vessel.

While the invention has been disclosed in connection with certain preferred embodiments, this should not be taken as a limitation to all of the provided details. Modifications and variations of the described embodiments may be made without departing from the spirit and scope of the invention, and other embodiments should be understood to be encompassed in the present disclosure as would be understood by those of ordinary skill in the art.

1. A system for storing and dispensing a carbonated fluid, the system comprising:
a flexible bag including a carbonated liquid therein; said bag including a connector allowing for liquid flow into and out of said bag and a connector for allowing gas flow into said bag;
a rigid sleeve sized and shaped to encapsulate said bag, said bag contacting said sleeve when said bag is filled with a carbonated liquid and internally pressurized;
a gas source, said gas source connected to said connector for allowing gas flow into said bag so as to provide gas into said bag which gas internally pressurizes said bag;
a regulator to control gas flow into said bag and liquid flow from said bag so that internal pressure of said bag can be maintained during dispensing of said carbonated liquid; and
an outer housing enclosing said bag and said sleeve.

2. The system of claim 1, wherein said gas provided by said gas source comprises carbon dioxide.

3. The system of claim 1, wherein said gas provided by said gas source comprises nitrogen.

4. The system of claim 1, wherein said carbonated liquid comprises beer.

5. The system of claim 1 further comprising: a source of refrigerant for reducing a temperature of said carbonated liquid.

6. The system of claim 1, wherein inner dimensions of said rigid sleeve correspond to outer dimensions of said bag.

7. The system of claim 1, wherein inner dimensions of said rigid sleeve are smaller than outer dimensions of said bag.

8. The system of claim 1, wherein said connector allowing for liquid flow into and out of said bag is a separate connector from said connector for allowing gas flow into said bag.

9. The system of claim 1, wherein said connector allowing for liquid flow into and out of said bag and said connector for allowing gas flow into said bag are the same connector.

10. The system of claim 1, wherein said connector allowing for liquid flow into and out of said bag and said connector for allowing gas flow into said bag are located at different parts of said bag.

11. A method for dispensing a carbonated fluid, the method comprising:
providing a flexible bag including a carbonated liquid therein; said bag including a connector allowing for liquid flow into and out of said bag and a connector for allowing gas flow into said bag;
providing a rigid sleeve sized and shaped to encapsulate said bag, said bag contacting said sleeve when said bag is filled with a carbonated fluid and internally pressurized;
injecting a gas via said connector for allowing gas flow into said bag to internally pressurize said bag; and
withdrawing liquid from said bag while maintaining the internal pressure of said bag.

12. The method of claim 11, wherein said gas comprises carbon dioxide.

13. The method of claim 11, wherein said gas comprises nitrogen.

14. The method of claim 11, wherein said carbonated liquid comprises beer.

15. The method of claim 11 further comprising: reducing a temperature of said carbonated liquid.

16. The method of claim 11, wherein inner dimensions of said rigid sleeve correspond to outer dimensions of said bag.

17. The method of claim 11, wherein inner dimensions of said rigid sleeve are smaller than outer dimensions of said bag.

18. The method of claim 11, wherein said connector allowing for liquid flow into and out of said bag is a separate connector from said connector for allowing gas flow into said bag.

19. The method of claim 11, wherein said connector allowing for liquid flow into and out of said bag and said connector for allowing gas flow into said bag are the same connector.

20. The method of claim 11, wherein said connector allowing for liquid flow into and out of said bag and said connector for allowing gas flow into said bag are located at different parts of said bag.
